(19) United States
(12) Patent Application Publication
(10) Pub. No.: US 2021/0178691 A1
(43) Pub. Date: Jun. 17, 2021

(54) SYSTEM, APPARATUS, AND METHODS FOR DISTRIBUTING POWDER FOR ADDITIVELY MANUFACTURED PARTS

(71) Applicant: MARKFORGED, INC., Watertown, MA (US)

(72) Inventors: Gregory Thomas Mark, Newton, MA (US); Benjamin Hodsdon Gallup, Acton, MA (US)

(21) Appl. No.: 17/120,541

(22) Filed: Dec. 14, 2020

Related U.S. Application Data
(60) Provisional application No. 62/947,826, filed on Dec. 13, 2019.

(51) Int. Cl. B29C 64/35; B33Y 10/00; B33Y 30/00; B33Y 40/20; B28B 1/00; B22F 10/14; B22F 10/68; B22F 12/53; B22F 12/52; B22F 12/63; B29C 64/165; B29C 64/209; B29C 64/218; B29C 64/329

(52) U.S. Cl. CPC B29C 64/35; B29K 2505/00; B33Y 30/00; B33Y 40/20; B28B 1/001; B22F 10/14; B22F 10/68; B22F 12/53; B22F 12/52; B22F 12/63; B29C 64/165; B29C 64/209; B29C 64/218; B29C 64/329; B33Y 10/00

(57) ABSTRACT

A system, apparatus and methods of additively manufacturing an object is disclosed. Specifically, provided herein are systems and methods of distributing powder within a build chamber for a layer-by-layer binderjet process. Distributing powder including apparatus and methods for uniformly densifying powder within the build chamber are also disclosed herein.

### CROSS-REFERENCE TO RELATED APPLICATIONS

This application claims priority under 35 U.S.C. § 119(e) to U.S. Provisional Application Ser. No. 62/947,826, titled “System, Apparatus, And Methods For Distributing Powder For Additively Manufactured Parts” filed Dec. 13, 2019, which is incorporated herein by reference in its entirety for all purposes.

### SUMMARY

In accordance with an aspect, there is provided an apparatus for additively manufacturing an object. The apparatus may comprise a build chamber defined by a volume, an extruder positioned over the volume of the build chamber, and one or more delivery heads configured to deliver at least one impulse to the build chamber.

In some embodiments, the one or more delivery heads may be further configured to asymptotically settle, through application of the delivered at least one impulse, fresh and/or loose powder within the build chamber to form an unbound settled powder,

In some embodiments, the one or more delivery heads may be further configured to fluidize, through application of the delivered at least one impulse, unbound settled powder within the build chamber for removal from the build chamber.

In some embodiments, the one or more delivery heads may be a mallet. For example, the mallet may be configured to deliver a single impact to a base of the build chamber or may be configured to deliver a plurality of impacts to the base of the build chamber.

In further embodiments, the apparatus may comprise a piston where a head of the mallet is adapted to an end of the piston.

In some embodiments, the one or more delivery heads may comprise a mallet and the at least one impulse may be delivered to a location substantially geometrically central to a base of the build chamber. In some embodiments, the one or more delivery heads may comprise a mallet and the at least one impulse may be delivered to a location substantially center of mass to the volume of the build chamber.

In some embodiments, the one or more delivery heads may comprise a source of vibrational energy.

In some embodiments, the one or more delivery heads are configured to deliver impulses to the build chamber such that a density of the unbound settled powder is substantially uniform.

In some embodiments, the extruder comprises a binderjet extruder configured to translate across a surface area the volume of the build chamber. The extruder may be configured to selectively jet binder to form portions of bound powder across a surface of the volume of the build chamber.

In some embodiments, the one or more delivery heads may comprise a mallet configured to deliver the impulses to a surface of the build chamber.

In further embodiments, the one or more delivery heads may comprise a roller. In further embodiments, the one or more delivery heads may comprise a powder hopper.

In some embodiments, a base of the build chamber may be configured to translate along a z-axis of the apparatus.

In some embodiments, the one or more delivery heads may be configured to deliver impulses to the build chamber when the base of the build chamber is elevated away from at least one side of the build chamber.

In some embodiments, a base of the build chamber may comprise one or more coverable openings.

In further embodiments, the apparatus may include a vacuum source operatively coupled to the build chamber.

In accordance with an aspect, there is provided a method of forming an additively manufactured object. The method may comprise depositing a layer of a powder into a build chamber, selectively jetting binder ink from an extruder onto at least a portion of the powder to form a selectively jetted bound powder and a remaining amount of unbound powder, and delivering at least one impulse to the build chamber.

In some embodiments, delivering at least one impulse may include delivering the at least one impulse to asymptotically settle the powder to form a settled unbound powder and wherein selectively jetting the binder ink includes jetting the binder ink onto the settled unbound powder.

In some embodiments, the delivered at least one impulse may fluidize a portion of the remaining amount of unbound powder in the build chamber for removal.

In some embodiments, the delivering may comprise impacting one or more delivery heads with a surface of a base of the build chamber. For example, the delivering may comprise impacting surface of a base of the build chamber with the one or more delivery heads adapted to an end of a piston. In some embodiments, the delivering may comprise impacting surface of a base of the build chamber with the one or more delivery heads being a mallet.

In some embodiments, the delivering may comprise delivering a single impulse. In some embodiments, the delivering may comprise delivering a plurality of impulses. In further embodiments, the delivering may comprise delivering an impact to a surface of the base of the build chamber. In further embodiments, the delivering may comprise delivering an impact the base at a location that is substantially geometrically central to the base of the build chamber. In further embodiments, the delivering may comprise delivering an impact to the base at a location that is substantially near the center of mass of the build chamber.

In some embodiments, the delivering may comprise application of vibrational energy to a surface of a base of the build chamber. The applying of vibrational energy may comprise actuating a vibration source operatively coupled to the build chamber.

In further embodiments, the method may comprise opening one or more coverable openings in a base of the build chamber. The delivery of the at least one impulse to the build chamber may fluidize a portion of the remaining amount of unbound powder and allow it to pass through the opened one or more coverable openings.

In some embodiments, the delivery of the at least one impulse to the build chamber may result in a density of the unbound settled powder that is substantially uniform.

In some embodiments, the delivering may comprise generating sound with a speaker and transmitting the sound to the build chamber the speaker.

In further embodiments, the method may comprise translating a base of the build chamber along the z-axis. In further embodiments, the method may comprise delivering at least one impulse to the build chamber while the base of the build chamber is elevated above at least one wall of the build chamber.

In further embodiments, the method may comprise adjusting the repetition rate of the at least one impulse delivered to the build chamber to substantially correspond to a resonant frequency of the build chamber.

In further embodiments, the method may comprise depositing subsequent fresh and/or loose powder to the build chamber and delivering at least one impulse to the build chamber to asymptotically settle the powder to form a settled unbound powder.

In further embodiments, the method may comprise, prior to the step of depositing subsequent powder to the build chamber, translating a base of the build chamber along a z-axis of the apparatus at a repeatable z-axis step position.

### BRIEF DESCRIPTION OF THE DRAWINGS

The accompanying drawings are not drawn to scale. In the drawings, each identical or nearly identical component that is illustrated in the various figures is represented by a like numeral. For purposes of clarity, not every component may be labeled in every drawing. In the drawings:

FIGS. 1A-IE illustrate asymptotic settling of a powder in a build chamber, according to one embodiment. FIG. 1A illustrates a build chamber with the powder not settled having volume V1. FIG. 1B illustrates the powder of in FIG. 1A partially settled to volume V2. FIG. 1C illustrates the powder of FIG. 1B further settled to volume V3. FIG. 1D illustrates the build chamber of FIG. 1A where the delivery head is a mallet. FIG. 1E illustrates the build chamber of FIG. 1A where the delivery head is a mallet adapted to an end of a piston.

FIG. 2 illustrates a schematic of the delivery head as a speaker configured to generate and transmit an audible impulse shock to the build chamber.

FIG. 3 illustrates a graph plotting the data from delivering a plurality of single impulses to the build chamber using a mallet, asymptotically settling the powder.

FIGS. 4A-4D illustrate removal of unbound powder following binderjet printing, according to one embodiment. FIG. 4A illustrates formed parts surrounded by unbound powder elevated above the build chamber. FIG. 4B illustrates the powder becoming fluidized after a first delivered impulse. FIG. 4C illustrates a side-by-side comparison of FIGS. 4A and 4B. FIG. 4D illustrates the exposed parts after a plurality of impulses delivered to the build chamber.

### DETAILED DESCRIPTION

The present disclosure provides systems and methods for additively manufacturing three-dimensional objects formed via a layer-by-layer binder jetting, e.g., “binderjet,” printing process from powder. The disclosed systems and methods deliver at least one impulse to a build chamber of a powder bed printer at different stages of the printing process to change the state of aggregation of the powder in the build chamber. For example, in one embodiments, at least one impulse is delivered to the build chamber to settle, for example, gravitationally settle, fresh and/or loose powder present within the volume defined by the build chamber and increase its density. In another embodiment, at least one impulse is delivered to the build chamber to fluidize the densified powder within the build chamber to permit gross depowdering, i.e., removal of powder, around formed parts. Gross depowdering where most, if not all of the powder is removed from green and brown parts formed in a binderjet printing process may be advantageous as it may improve efficiency, reduces costs, and increase safety due to lower exposure to particulates.

Apparatus include, for example, a delivery head delivers at least one impulse to the build chamber, momentarily energizing powder present in the build chamber, for example, through a mechanical impulse, an audible impulse, or combinations thereof. Systems, apparatus, and devices are further configured to deliver a plurality of impulses. For example, the systems, apparatus, and devices disclosed herein may deliver any number of impulses, e.g., 1 impulse, 2 impulses, a plurality of impulses, or any number of impulses, and so on, to the build chamber. An impulse delivered from a delivery head can momentarily energize fresh and/or loose powder that is present within the build chamber. The fresh and/or loose powder present, when momentarily energized by such an impulse, asymptotically settles within the build chamber such that the powder approaches its lowest energy state. As the powder approaches its lowest energy state, the powder is characterized as approaching its highest density, that of an unbound settled powder. In a layer-by-layer binderjet process, after the delivery head delivers at least one impulse, a binder is selectively jetted on the unbound settled powder. The present disclosure further provides for the gross depowdering of parts formed from the layer-by-layer binderjet process. The remaining powder can be removed from the systems, apparatus, and devices disclosed herein by delivering at least one impulse to a build chamber to fluidize the powder and allow it to fall away from the formed parts in the build chamber.

The present disclosure further provides methods for additively manufacturing an object. Disclosed methods include additively manufacturing an object via a layer-by-layer binderjet process in which steps include uniformly densifying fresh and/or loose powder. Specifically, the present disclosure provides methods of delivering at least one impulse to a build chamber that settles fresh and/or loose powder present within the build chamber defined by a volume. Methods further include delivering at least one impulse from a delivery head to the build chamber to momentarily energize fresh and/or loose powder present within the build chamber. Methods further include delivering a plurality of impulses, for example, from the delivery head to the build chamber to momentarily energize the fresh and/or loose powder present within the build chamber. Methods further include delivering an impulse that is, mechanical in nature, audible in nature, or combination thereof. As above explained, when delivering an audible or mechanical impulse to the build chamber, fresh powder within the build chamber is momentarily energized by such an impulse, asymptotically settles within the build chamber. Disclosed methods include delivering at least one impulse that momentarily energizes the fresh and/or loose powder that is present within the build chamber such that it asymptotically settles the powder within the build chamber. The powder approaches its lowest energy state, as above noted, characterized as approaching its highest density as an unbound settled powder. Methods further include delivering at least one impulse from a delivery head to a build chamber to fluidize the settled powder and allow it to fall away from the formed parts in the build chamber. In some aspects, the fluidized powder approaches a high energy state and lower density, allowing it for fall away from the formed parts.

According to apparatus and methods as disclosed herein, at least one impulse delivered to the build chamber can momentarily energize fresh and/or loose powder in a build chamber to settle the powder within the build chamber or fluidize settled powder in a build chamber to allow it to fall away from the formed parts in the build chamber. Moreover, when a plurality of impulses are delivered to the build chamber, each momentarily energizes the fresh and/or loose powder and asymptotically settles the powder within the build chamber or fluidizes the settled powder and allows it to fall away from the formed parts in the build chamber. Indeed, at least one impulse delivered to the build chamber momentarily energizes the fresh and/or loose powder and asymptotically settles the powder within the build chamber to form an unbound settled powder. By asymptotical, it is meant the apparent density of the unbound powder is approaching the limit of the unbound settled powder. The energized powder loses energy such that the powder approaches its lowest energy state. As the powder approaches its lowest energy state, the powder is characterized as approaching its highest density, the unbound settled powder.

### Powder-Based Deposition

A key challenge in manufacturing parts is the ability to make consistent parts. The goal when manufacturing consistent parts is repeatedly making parts such that each final part has the same size, the same shape, the same features, and the same characteristic properties. Part-to-part consistency and uniformity further makes predictable performance of resultant parts possible. Subsequent manufacturing or processing with these parts, that is, forming downstream products with parts or using parts, particularly with regard to downstream product performance, relies on the consistency and uniformity of the parts (e.g., part tolerances).

Traditional subtractive methods of manufacturing start with a block of material that transitions to a part by strategically carving or removing material from the block until the desired part remains. In contrast to these traditional subtractive methods, additive manufacturing of parts starts with an empty platform and a supply of one or more feed materials that are combined, processed, and/or used via building to form a part. Some additively manufactured parts are grown, layer-by-layer to from a final part.

Various layer-by-layer methods of additive manufacturing utilize a powder as a feed or starting material. Powders can, for example, include metals, ceramics, and combinations thereof. Powders can, for example, include particulates of these metals or ceramics. Characteristics of powders may include, for example, average size of particles of the powder, their size distribution, and/or a composition of the powder. In typical layer-by-layer processing systems, powder is deposited, fed, or gravity spread from a powder hopper located above a build chamber across a surface of a volume of a build chamber, for example, a powder bed or powder receptacle, to form a layer of fresh and/or loose powder in the build chamber.

In some embodiments, an extruder may be positioned above the powder and the build chamber is configured to selectively jet binder onto portions of the powder. The jetted binder is glue-like and configured to allow the particles of the powder to which it is applied to adhere to one another. When a liquid binder is selectively jetted on or patterned into successive layers of powder in the build chamber, the layers of the powder adhere to one another. Selected portions of the powder are bonded, that is, glued or adhered together, to make one layer of the part. i.e., one layer of the desired three-dimensional bound object.

Fresh and/or loose powder may be deposited on top of an immediate prior bound layer. The extruder may selectively jet binder onto the fresh powder within the volume of the build chamber. A selected portion of that layer is bonded together, and to the layer below. This process, termed binderjet printing, may be repeated until a part is made. After repeating and once a desired part is formed, the part may be moved to de-powdering, where loose powder or un-bound powder is removed from the part. As used herein, a “green part” is a bound powder part that has had the loose or un-bound powder removed, for example by delivering at least one impulse to the build chamber to fluidize the settled unbound powder and allow it to fall away from the formed parts in the build chamber.

A green part may be moved to a furnace where the green part is sintered, resulting in a formation of a solid object, i.e., a final part. In the furnace, heat is applied and the binder is burned off or out of the green part. Further, with heat, the powder particles fuse together to form the solid object. During the sintering process, the green part undergoes a reduction in volume down to a final part shape.

Without wishing to be bound by any particular theory, during a sintering process, an object collapses down into itself, e.g., by a ratio or a proportionally. As a powder material melts and collapses down, the empty spaces between powder particles may become filled, e.g., substantially filled, or at least proportionally filled with neighboring powder particles. An amount of collapse to the final solid object may be proportional to the density of the green part. Forming consistent, repeatable, and/or uniform final parts therefore at least, in part, relies on a consistent, repeatable, and/or uniform density after the fresh powder or loose powder is applied and before application of the binder.

The present disclosure encompasses a recognition that accurately predicting an amount of volume reduction of collapse, proportion of volume reduction of collapse, reduction or collapse rate, and combinations thereof relies on a forming, having, or starting with a uniformly densified powder when a binder is applied thereto, that is, starting the unbound settled powder.

### Powder Spreading

Variations inherent in traditional spreading systems, apparatus and methods may introduce less than desirable deviations in an amount of powder distributed at any one location and in a density or compaction of the powder distributed across areas of the build chamber. Deviation or variation within each layer manifests in differences in powder compacting, consolidating, compressing, densifying, relaxing, and/or gravitationally settling. Deviations in the density of the powder deposited into the build chamber may result in non-uniform density of the full powder mass deposited in the build chamber. For example, under this scenario, certain areas of a powder layer may have more of the powder material packed into a specified area or volume. Without wishing to be bound by any particular theory, for an area that receives more powder than another area of a layer, the area with the increased powder may have a higher compaction than another area of a layer or may have a higher density than another area of a layer. Such variations reduce the likelihood of producing consistent and uniform parts, and, subsequently reduces the likelihood of producing consistent and uniform downstream products.

Downstream products may be affected by intralayer deviations and variations. Intralayer variation in powder layer height and/or powder layer density in a build chamber can produce multiple parts (e.g., from a multi-part run) exhibiting a distribution of characteristic properties or a single part (e.g., from a single part run) exhibiting a distribution of characteristic properties that vary within or across the single part. In a build chamber in which many separate parts are manufactured, for example, many of the same part, the characteristic properties and mechanical specifications may fail to meet individual part tolerance. For example, one part of a lot may be sized over specification, another part of the lot may lack specified features, and another part of the lot may have a tensile strength below specification. Additionally, in a build chamber in which a single part is manufactured, such as a single “large” part, uniformity within said part can be affected. For example, a portion of a “large” part could be weaker because powder density is lower in both the build chamber and the corresponding area of the “larger” part therein.

Deviations and variations in traditional powder spreading processes described herein within each layer may further extend to deviations and variations between neighboring or separate layers, or across entirely separate processing runs. For example, when a subsequent fresh layer of powder is added to the build chamber, the newly added powder layer may have more powder material packed into one area or volume when compared to a corresponding area or volume within another layer. As explained above, the variation can locally affect formed parts. When compared layer-by-layer, such deviations and variations can affect final part uniformity and consistency in addition to part strain, stress, and ‘z’ strength. Additionally, variations and/or deviations in powder spreading within layers, and between layers can further exhibit between processing runs.

### Powder Compaction

The present disclosure encompasses a recognition that uniform and consistent parts and products with respect to their characteristic properties may be, at least in part, a result of a uniformly dense loose powder or fresh powder layers within a build chamber before the powder is selectively bound.

A powder spreader, for example, a roller, deposits powder into a build chamber. Such a deposition of powder forms a low-density layer. A low-density layer of deposited powder may be loose powder, fluffy powder, or fresh powder. Low density powder layers can be densified, made more uniform, and/or partially compacted. For example, a powder spreader, such as a roller, can densify the low-density layer by forcing the air from the interstitial spaces between powder particles.

However, a roller compacting loose powder cannot typically bring the loose powder to its lowest energy state, or have the loose powder transform to approach its highest density. For instance, during rolling of a given layer, a roller will compact the underlying fresh powder layer more or less depending on a number of factors. For example, the pressure applied to the roller, the roller material, the surface quality of the roller, the surface area of the roller, the material of powder, the density of the powder as laid, the surface of the powder, may affect the compaction of the powder layer. If, for example, more force is applied to the roller to achieve additional compaction, the underlying (and supporting) powder bed structure may crack or shift. Cracking and shifting may be a high probability event with compaction from additional applied pressure to the roller because each partially compressed layer below a newly applied layer has a potential to compress more, and, therefore shift down, give way, crack and/or shift.

Existing roller assemblies thus only partially press down on loose powder layers (that is, among other reasons know in the art, such as reducing dragging and cutting problems). Without wishing to be bound to a specific theory, it is believed that the lack of additional, complete, or full compaction of loose powder in a build chamber is the reason existing build chambers with traditional powder compaction are non-uniform.

Another device used for the compaction of powder materials may include, for example, a two-sided compactor. A two-sided compactor may include compression plates configured to fit within the walls of the top and bottom surfaces of the print bed. The compression plates move toward each other to apply compressive force on the powder material therebetween, with the walls of the print bed preventing powder leakage. In addition, compaction of powder may be achieved, for example, by uniformly spreading powder using a plurality of rollers for dispensing powder. Described systems and methods herein include two or more rollers that rotate relative and counter-direction to one another. The rotating and counter-rotating rollers work to disperse powder and apply downward force to the powder. As above described, such compaction or downward force likely results in cracking and/or shifting of a powder bed.

Additional methods of compaction include, for example, vibrating a roller contacting the powder or vibrating a device contacting the powder. Described methods include, for example, contacting the roller or device, that is configured to vibrate with powder in the build chamber and moving the roller across a surface of the volume of the build chamber. The vibrating roller makes a pass over the surface of the volume of the powder bed before the binder jetting process to improve powder density. A pass occurs after each new layer of fresh powder is laid. There are several described variations of this vibrational method including, for example, using mechanical springs to vibrate the roller, using a voice coil send the vibration, a pressurized pump inside the roller to actuate vibrational flex from inside the roller. Described methods include vibrational frequencies of greater than about 1 kHz and less than about 1 MHz. The described methods explain that roller vibration frequency is beneficial in powder packing.

While not wishing to be bound to any specific theory, it is believed that inducing oscillations within the powder does nothing to compact, consolidate, compress, densify, and/or settle the powder within the powder bed. Indeed, it is believed that such oscillatory behavior excites the powder such that the gaps between powder particles are rearranged or reoriented. But, the vibrational behavior does not bring the powder towards its lowest energy state, or have it approach its highest density prior to green part formation.

### Systems, Apparatus, and Devices for Uniformly Settling Powder

As spreading fresh and/or loose powder layers may be inconsistent, the resultant green parts may have an inconsistent density, and, thus the resulting volume reduction, collapse, or rate of these processes of green parts may also be inconsistent. As above explained, these inconsistencies may lead to mechanical deformations, weaknesses, and non-uniformity of characteristic properties within parts, inconsistency of separate parts made within a same run, and inconsistency of parts made across separate runs. By contrast, the present disclosure encompasses a recognition that a build chamber having unbound settled powder before a binderjet printing process facilitates fabrication of internally consistent parts that can be used in end-use applications, that is, parts formed with consistent properties suitable for use in downstream products.

When a green part is uniformly dense, the green part may have uniform shrinkage when sintered such that the final part density, strength, fatigue resistance, are uniform, consistent, and predictable. Indeed, these final part characteristics may be uniform, consistent, and predictable across each part, separate parts within a single run, and parts across separate runs. Uniformly dense green parts may improve characteristic properties of three-dimensional objects. For example, uniformly dense green parts may reduce layer to layer variations in expected properties.

The present disclosure provides systems, apparatus and methods to form a uniformly dense powder, that is consolidated and/or settled within a build chamber defined by a volume. The present disclosure, in some embodiments, provides an apparatus for use with three-dimensional printing systems that may deliver at least one impulse to a build chamber. In some aspects, the apparatus may include a delivery head constructed and arranged to deliver at least one impulse to the build chamber. In some aspects, the delivery head constructed and arranged to deliver the at least one impulse to the build chamber momentarily energizes powder within the build chamber such that fresh and/or loose powder settles therein.

In some aspects, systems, apparatus, and devices as provided herein include a delivery head configured to deliver at least one impulse to the build chamber such that it momentarily energizes powder within the build chamber so that fresh and/or loose powder within the build chamber settles within an effected build chamber. In some aspects, the momentarily energized fresh and/or loose powder loses energy and may approach the lowest energy state and highest density state for the powder. In some aspects, the delivery of at least one impulse to the build chamber fluidizes the settled unbound powder and allow it to fall away from the formed parts in the build chamber. In some aspects, the fluidized powder approaches a high energy state and lower density, allowing it for fall away from the formed parts.

Without wishing to be bound to any specific theory, it is believed that at least one impulse delivered to a build chamber defining a volume holding fresh and/or loose powder momentarily energizes the powder such that the powder approaches its lowest energy state and settles within the build chamber and can fluidize the settled powder and allow it to fall away from the formed parts in the build chamber. In some aspects, settled powder includes, for example, compacted, consolidated, compressed, densified, and relaxed, and/or gravitationally settled powder within the build chamber. In some aspects, as the powder approaches its lowest energy state it is characterized as approaching its highest powder density. In some aspects, a fractional distance and/or a gap spacing between neighboring or near neighboring powder particles is reduced.

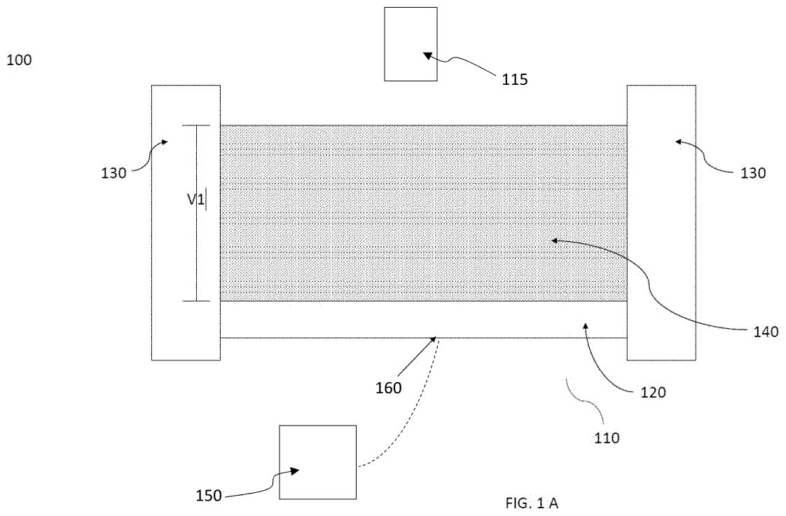

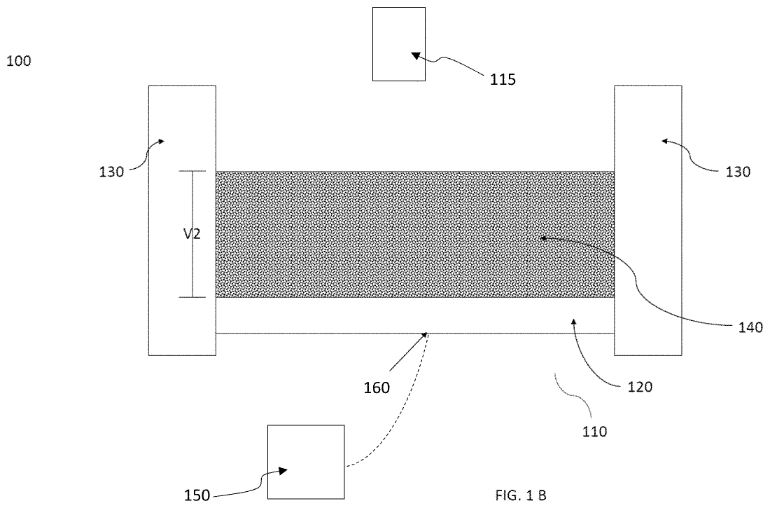

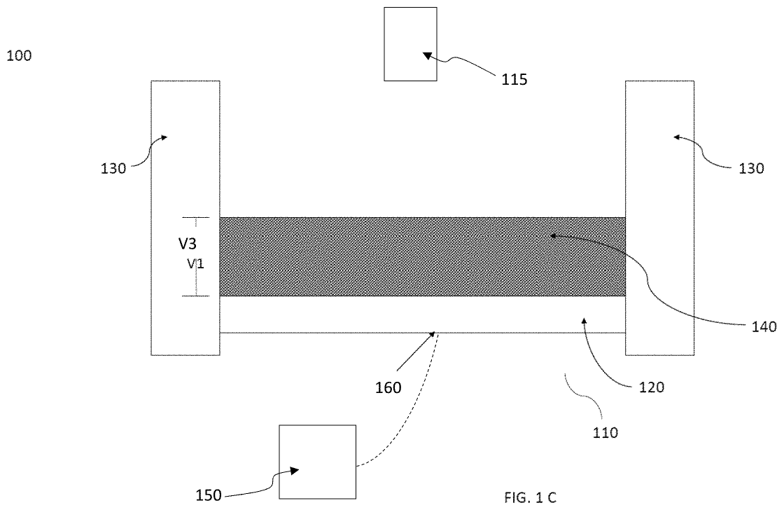

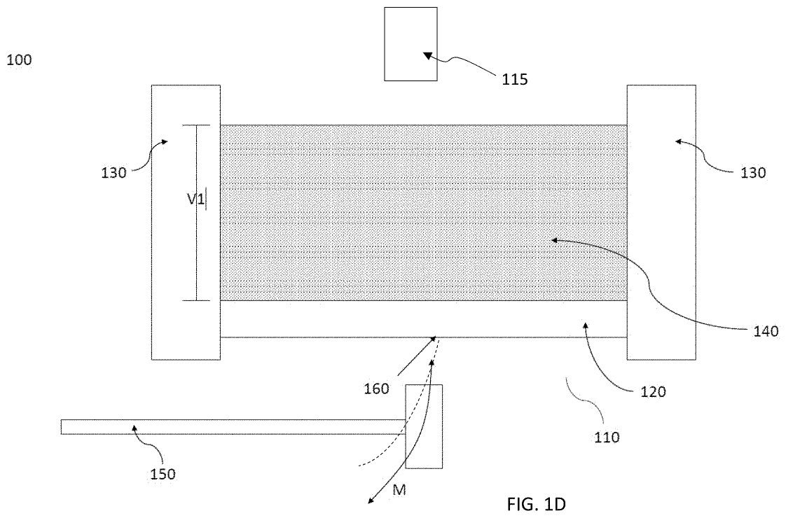

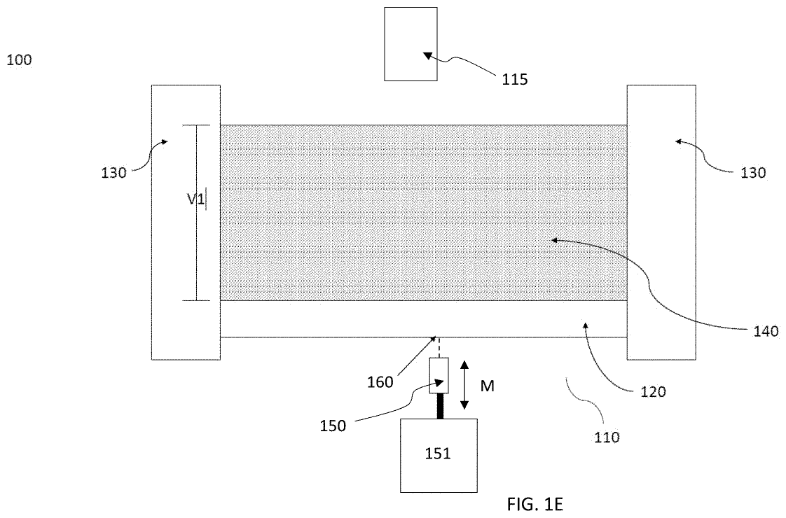

Referring to FIG. 1A, an additive manufacturing system 100 may include a build chamber 110 and an extruder 115 positioned over the build chamber 110. The build chamber 110 includes a base 120 and side surfaces 130. The build chamber 110 may define a volume in which, a three-dimensional object (not shown) may be formed, for example, by a bindejet process. The build chamber is configured to hold powder 140 (e.g., a powder including particles, such as metal particles, ceramic particles, or combinations thereof) that are deposited in the build chamber. A delivery head 150 is configured to contact the base at a location 160, with the dashed line from delivery head 150 indication motion of the delivery head to the location 160. As a non-limiting example, the delivery head 150 can be a mallet or similar striking device, such as a hammer. FIG. 1A further shows asymptotically settling powder 140 after at least one first impulse delivered to the build chamber 110 with the delivery head 150. The powder settles to a first volume, V1, representative of a first density. FIG. B shows asymptotically settling powder 140 after at least one second impulse delivered to the build chamber 110 with the delivery head 150. The powder 140 further settles to a second volume. V2, representative of a second density, greater than the first density. FIG. 1C shows asymptotically settling powder 140 after at least one third impulse delivered to the build chamber 110 with the delivery head 150. The powder 140 further settles to a third volume. V3, representative of a third density, greater than the second density. With reference to FIGS. 1D and 1E, various embodiments of delivery head 150 are illustrated. As a non-limiting example, FIG. 1D illustrates an embodiment where the delivery head 150 is a mallet 150. The mallet 150 is configured to contact the base at the location 160 following the curved arrow M. In another non-limiting example, FIG. 1E illustrates an embodiment where the delivery head 150 is a mallet 150 adapted to an end of a piston 151. The piston moves along arrow M to allow mallet 150 to contact the base at the location 160 following the dashed line.

In some aspects, impulses may be delivered after fresh and/or loose powder is deposited, fed, or spread within the build chamber. In some aspects, the build chamber, may include, for example a powder bed, a powder receptacle, a print platen, a powder platen, a print surface, a powder surface, and/or powder therein. In some aspects, a build chamber may define a volume for an additive manufacturing process, e.g., a binderjet printing process. In some aspects, the build chamber may define a shape for holding a volume of powder. In some aspects, a volumetric shape may include, for example, a circle, square, or rectangle, or any other geometric shape.

In some aspects, a build chamber may include a top or opening side surface. In some aspects, an opening side or top surface is a surface in which powder can be fed, e.g., by gravity. In some aspects, a top or opening side includes edging at least partially surrounding a surface thereof. In some aspects, a top or opening side includes at least some contactable surface or surfaces that are configured to respond to sound, physical contact, or combinations thereof.

In some aspects, a build chamber may include one or more sides or side surfaces. In some aspects, the one or more sides or side surfaces may include at least some contactable surface or surfaces configured to respond to sound, physical contact, or combinations thereof. In some aspects, a build chamber may include a base or bottom (e.g., gravitationally facing downward, that is, along a z-axis). In some aspects, as above disclosed, a base can gravitationally support powder within a build chamber. In some aspects, a base may include at least some contactable surface configured to respond to sound, physical contact, or combinations thereof. In some aspects, a base may include edging at least partially surrounding it. In some aspects, disclosed surfaces, corners, and edging are configured to receive and respond to impulse shocks.

In some embodiments, a surface of a build chamber can include a top surface, side surface, base surface, edges, corners, or combinations thereof. In some aspects, a delivery head may be positioned or located to deliver an impulse shock at about a center of a surface area of the surface of a build chamber. In some aspects, a delivery head may be positioned or located to deliver an impulse shock at about a center of mass of the volume of powder present within a build chamber.

In some aspects, impulses delivered by the delivery head may be configured to provide at least one impulse of a mechanical nature, an audible nature, or combinations thereof. As above disclosed, such an impulse momentary energizes loose powder within the build chamber, thereby causing it to settle, for example gravitationally settle, and thereby drop down from gravity. In some aspects, momentary energizing the powder causes it to increase in density.

In some aspects, the apparatus may include a delivery head constructed and arranged to deliver at least one impulse to the build chamber. e.g., a surface of the build chamber. In some aspects, at least one impulse delivered to the build chamber may include an impact, which can include for example, a blow, a collision, a contact, or a force. In some aspects, an impulse may be delivered to one or more sides, surfaces, edges, or corners of the build chamber. In some aspects, the impulse may be delivered to the build chamber.

In some aspects, a delivery head may deliver at least one impulse to the build chamber. In some aspects, to deliver includes convey, distribute, or transmit. In some aspects, a delivery head may deliver at least one impulse to a bottom of a build chamber. In some aspects, a delivery head may deliver at least one impulse to a top surface of a build chamber. In some aspects, a delivery head may deliver at least one impulse to a side surface of a build chamber. In some aspects, a delivery head may deliver at least one impulse to a corner or edge of a build chamber.

In some aspects, the at least one impulse may be delivered by a mallet configured to impact the build chamber. In some aspects, a mallet may include, for example, a compression pad, hammer, roller, a secondary powder spreader, a rod, or any solid or hollow geometric shape. In some aspects, the at least one impulse may be delivered by a plurality of delivery heads. For example, the at least one impulse may be delivered by a plurality of mallets. In some aspects, one or more mallets may be positioned or located on a surface of a build chamber. In some aspects, a mallet may be positioned at or adapted to an end of a piston. In some aspects, a mallet may be positioned at an end of an arm constructed to swing along a defined curvature. In any aspect comprising one or more mallets, the repetition rate of mallet impacts to the build chamber may substantially correspond to a resonant frequency of the apparatus to facilitate densification of and subsequent fluidization of the powder in the build chamber.

In some aspects, the at least one impulse may be delivered by a non-point impulse source, such as a rotary stage, a vibratory stage, or vibratory table supporting the apparatus or a component thereof, e.g., the build chamber. In this configuration and as described herein, the repetition rate and/or intensity of the vibrational motion may substantially correspond to a resonant frequency of the apparatus to facilitate densification of and subsequent fluidization of the powder in the build chamber.

In some aspects, the apparatus may include a delivery head configured to deliver a single audible impulse shock. In some aspects, a single audible impulse shock may be generated and transmitted by a speaker. In some aspects, a single audible impulse shock may be generated and transmitted by a voice coil.

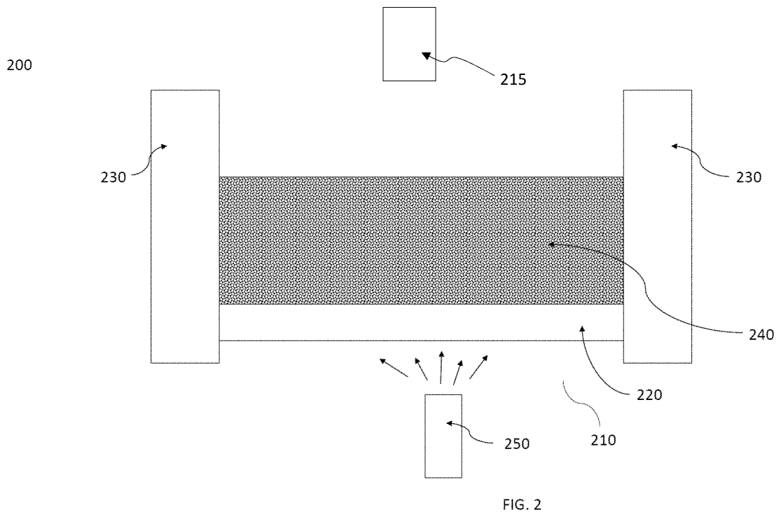

Referring to FIG. 2, an additive manufacturing system 200 may include a build chamber 210 and an extruder 215 positioned over the build chamber 210. The build chamber 210 includes a base 220 and side surfaces 230. The build chamber 210 may define a volume in which a three-dimensional object (not shown) may be formed, for example, by a binderjet process described herein. The build chamber 210 is configured to hold powder 240 (e.g., a powder including particles, such as metal particles, ceramic particles, or combinations thereof) that are deposited in the build chamber 210. A speaker 250 positioned beneath base 220 is configured to generate and transmit sound at the base 220.

In some aspects, the apparatus includes a piezoelectric material as a coating on a surface of the build chamber, such as a base. When an applied electric field is applied to the piezoelectric material, the coating responds by inducing a mechanical stress or strain on the surface of the build chamber. The forces of the stress or strain may be transferred to the unbound powder within the build chamber to either densify the powder to form unbound settled powder or fluidize the unbound settled powder for gross depowdering following printing.

In some aspects, systems, apparatus, and devices as provided herein may include a delivery head constructed and arranged to deliver at least one impulse to the build chamber to momentarily energize powder within the build chamber so that fresh and/or loose powder within the build chamber settles within the build chamber and/or to fluidize the settled unbound powder and allow it to fall away from the formed parts in the build chamber. In some aspects, the momentarily energized fresh and/or loose powder loses energy and may approach the lowest energy state and highest density state for the powder. In some aspects, the fluidized powder approaches a high energy state and lower density, allowing it for fall away from the formed parts. In some aspects, systems, apparatus, and devices as provided herein may include a delivery head constructed and arranged to deliver a plurality of impulses to the build chamber such that each impulse momentarily energizes powder within the build chamber so that fresh and/or loose powder within the build chamber settles within the build chamber and/or fluidizes the settled unbound powder and allow it to fall away from the formed parts in the build chamber. In some aspects, the momentarily energized fresh and/or loose powder loses energy to approach the lowest energy state and highest density state for the powder. In some aspects, after a single impulse, a subsequent series of single impulses further increases a density of the loose powder or fresh powder until the powder present within the build chamber asymptotically reaches its lowest energy state (i.e., its highest density). In some aspects, the delivery of at least one impulse to the build chamber fluidizes the settled unbound powder and allow it to fall away from the formed parts in the build chamber. In some aspects, the fluidized powder approaches a high energy state and lower density, allowing it for fall away from the formed parts.

In some aspects, a powder layer may be asymptotically settled before the next powder layer is applied. In some aspects, a powder layer may be about 95% asymptotically settled before the next powder layer is applied. In some aspects, a powder layer may be substantially asymptotically settled before the next layer is applied. In some aspects, an impulse may cause fresh powder to settle within a build chamber at a height lower than that applied or spread by a roller.

In some aspects, the at least one impulse delivered from a delivery head to the build chamber momentarily energizes the powder therein. In some aspects, the repetition rate of the at least one impulse may be tuned to a resonant frequency of the apparatus, including powder within the build chamber, to optimize the packing efficiency of the powder particles, e.g., to increase the density of the powder within the powder bed or maximize the removal of unbound powder particles after printing a green part. Without wishing to be bound by any particular theory, application of at least one impulse at a repetition rate substantially similar to the natural resonant frequency of the apparatus maximizes the forces applied to the powder particles in the build chamber. The increased force applied improves the efficiency of reorganizing the particles into or close to their lowest energy state, thus increasing the apparent density of the powder in the build chamber. The resonant frequency of the apparatus may be a function of the apparatus itself and any component thereof, e.g., the size, shape, and material of the build chamber, the mass of the powder dispensed into the build chamber, and the physical and chemical characteristics of the powder. e.g., type of powder, particle size distribution, or density.

In some aspects, when approaching a highest powder density state within a build chamber, the powder density within the build chamber may be uniform. In some aspects, when approaching a highest powder density state within a build chamber, the powder density within the build chamber may be substantially uniform. In some aspects, when approaching a highest powder density state, the powder density may be uniform for an unbound settled powder before binder is selectively jetted. In some aspects, when approaching a highest powder density state, the powder density may be substantially uniform for an unbound settled powder before binder is selectively jetted.

In some aspects, approaching a highest powder density state for the fresh and/or loose powder, for example, using some commercially available metal injection molding (MIM) powders, may result in an unbound settled powder having a density of between about 3 g/cm³ and about 6 g/cm³.

In some aspects, systems as described herein may include an extruder positioned to jet a binder material, e.g., binder ink, at least over a surface the volume of the build chamber. In some aspects, the extruder may be translatable across a surface area at least traversing that of the volume of the build chamber. As above disclosed, the binder ink may be selectively jetted onto a fresh powder layer to form a bound layer. In some aspects, a selectively jetted layer includes bound powder and unbound powder. In some aspects, systems as described herein may include a stepper to translate a build chamber after formation of a bound layer. In some aspects, after a green part is formed, the green part may be further processed to form an additively manufactured object, e.g., a part.

In some embodiments, systems, devices, and apparatuses disclosed herein may also be configured for the removal of unbound powder, e.g., depowdering, from green parts formed during the binderjet printing process. Depowdering a binderjet fusion part can be a complicated step of the binderjet process. Complications may arise in depowdering due to the limited tensile strength of the green parts and the excess mass of the remaining powder applying compressive forces to the green parts. Removal by dragging or lifting the green part through the remaining unbound powder may create nontrivial forces capable of damaging the green part, such as breaking a feature or cracking the part itself. Previous techniques of gross depowdering include manually brushing or displacing the powder with compressed air, which is both inefficient and creates a potential hazard for airborne particulate matter.

As described herein, systems, devices, and apparatuses disclosed herein provide for delivering at least one impulse to a build chamber. The at least one impulse, or a plurality thereof, shocks or vibrates the powder, which fluidizes and flows under the influence of gravity. The use of impulses or vibrations to fluidize the unbound powder and allow it to fall away from the green parts within is advantageous as it reduces the forces applied to the green parts, thus reducing potential damage to the green parts. In some aspects, the bottom of the build chamber may be constructed and arranged to translate along the z-axis as defined herein. The translation of the bottom of the build chamber along the z-axis may allow for the densified powder to be positioned away from any of the walls of the build chamber used to define its volume. In this configuration, the powder used to create the green parts in the build chamber, once fluidized by the delivery head delivering at least one impulse or a plurality thereof to the build chamber, can flow down and away from the green parts within the powder. In some aspects, the bottom of the build chamber may include one or more coverable openings sized and shaped to allow fluidized powder to pass once opened. In this configuration, the powder mass in the build chamber need not be translated along the z-axis to facilitate gross depowdering. After printing the green part, the one or more coverable openings may be opened, and the at least one impulse applied to the build chamber. The at least one impulse fluidizes the unbound settled powder within the build chamber to permit it to pass through the openings in the bottom of the build chamber. In any aspect of depowdering described herein, the depowdering may be assisted using a vacuum source, in part to mitigate potentially hazardous airborne particulates.

In some aspects, systems, devices, and apparatuses disclosed herein further may include any number of storage containers, such as a reservoir covered by a louver or a grating, to collect the unbound and now free flowing powder. The collected powder may be reused to form more green parts as described herein or disposed of.

The at least one impulse, or a plurality thereof, applied to the build chamber for gross depowdering may be applied by the same components used to densify or compact the powder in the build chamber. For example, depowdering may be achieved by a mallet, or its equivalent as described herein, contacting the build chamber to fluidize the unbound powder. In some aspects, depowdering may be achieved by the application of acoustic energy, such as by a speaker or voice coil positioned near a surface of the build chamber. Other sources of impulses or vibrations are possible, and this invention is not limited by the source of energy used to apply the at least one impulse to the build chamber.

### Methods

The present disclosure further provides methods of method of forming an additively manufactured object. The present disclosure, in some embodiments provides methods for delivering at least one impulse to a build chamber. In some aspects, when powder is present within a build chamber, a method may include a step of delivering at least one impulse to the build chamber to momentarily energizes the powder therein. In some aspects, the fresh and/or loose powder within the build chamber settles when it is momentarily energized by the at least one impulse. In some aspects, at least one impulse asymptotically settles the powder to form a settled unbound powder. In some aspects, settles (or settling) includes, for example, consolidates, densifies, and relaxes, and/or gravitationally settles within the build chamber. In some aspects, the at least one impulse fluidizes a portion of the unbound powder in the build chamber for removal.

In some aspects, methods disclosed herein may include delivering at least one impulse from a delivery head to the build chamber such that the impulse momentarily energizes the powder within the build chamber so that the powder asymptotically settles. In some aspects, such impulses may cause the powder to drop from gravity, e.g., downward, resulting in an increase in density of the powder. In some aspects, momentarily energizing the fresh and/or loose powder may result in an energy loss that approaches the lowest energy state for the powder and asymptotically settles said powder to form an unbound settled powder. In some aspects, methods disclosed herein may include delivering at least one impulse from a delivery head to the build chamber such that the impulse fluidizes a portion of the unbound powder in the build chamber for removal. In some aspects, delivering includes conveying, distributing, or transmitting impulses that momentarily energize powder therein so that the powder asymptotically achieves its lowest energy state. In some aspects, delivering includes conveying, distributing, or transmitting impulses that fluidizes a portion of the unbound powder in the build chamber for removal.

In some aspects, as the powder settles and approaches its lowest energy state, the powder resulting therefrom may be an unbound settled powder which is characterized as approaching its highest powder density. In some aspects, as the powder fluidizes and approaches a higher energy state, the powder resulting therefrom may fall free from the build chamber and away from green parts within the volume of the build chamber.

In some aspects, after fresh and/or loose powder is deposited in a build chamber, the methods disclosed herein may include delivering at least one impulse to a build chamber to form an unbound settled powder, thereby settling each powder layer without causing a shift or crack in the powder bed.

In some aspects, the methods disclosed herein may include delivering at least one impulse to a base of a build chamber. In some aspects, methods may include delivering at least one impulse to a top surface (i.e., where powder is added) of a build chamber. In some aspects, the methods disclosed herein may include delivering at least one impulse to a side surface of a build chamber. In some aspects, the methods disclosed herein may include delivering at least one impulse to a corner or edge of a build chamber. In some aspects, the methods disclosed herein may include delivering at least one impulse at about a center of a surface area of a surface (i.e., a top surface, a side surface, or a base) of the build chamber. In some aspects, the methods disclosed herein may include delivering at least one impulse at about at about a center of mass of the volume of powder present within a build chamber.

In some aspects, delivering at least one impulse may include delivering at least one impulse that is mechanical, audible, or a combination thereof. In some aspects, the methods disclosed herein may include delivering at least one impulse to a build chamber such that the delivery head neither mechanically contacts the fresh and/or loose powder within the build chamber nor directly compacts, consolidates, compresses, densifies, and/or settles powder within the build chamber. That is, in some aspects, the delivery head asymptotically settles fresh and/or loose powder within the build chamber. In some aspects, the methods disclosed herein may include impacting the build chamber with at least one impulse. In some aspects, the methods disclosed herein may include impacting the build chamber with at least one impulse using one or more delivery heads including a mallet. In some aspects, using a mallet may include the use of a roller or a powder hopper, or other apparatus as disclosed herein. In some aspects, the methods disclosed herein include delivering at least one impulse to the build chamber by applying vibrational energy to a surface of a base of the build chamber. For example, the applying of vibrational energy may include actuating a vibration source operatively coupled to the build chamber. In some aspects, the methods disclosed herein may include generating and transmitting to the build chamber at least one impulse using an audio speaker. In some aspects, the methods disclosed herein may include generating and transmitting to the build chamber an impulse shock using a voice coil.

In some aspects, the methods disclosed herein may include simultaneously delivering a plurality of impulses at one or more different locations of a surface of the build chamber. In some aspects, the methods disclosed herein further may include delivering subsequent impulses. In some aspects, the methods disclosed herein may further include delivering a plurality subsequent impulses. In some aspects, each impulse further may asymptotically settle the powder in the build chamber and increase the density of the powder until the powder bed reaches its lowest energy state, i.e., the highest density powder bed. In some aspects, each impulse further may fluidize the unbound settled powder in the build chamber and decrease the density of the powder until the powder bed reaches its highest energy state. i.e., the lowest density powder bed and falls away from the formed pats within the build chamber under the influence of gravity.

In some aspects, the methods disclosed herein may include asymptotically settling powder to form an unbound settled powder where the powder is about 95% asymptotically settled before the next powder layer is applied. In some aspects, the deposited powder may be uniformly dense before additional powder is deposited. In further aspects, the deposited powder may be substantially uniformly dense before additional powder is deposited.

In some aspects, the methods disclosed herein further may include selectively jetting binder from an extruder located over the volume of powder in the build chamber. In some aspects, the methods disclosed herein further may include translating the extruder over a surface of the volume of the powder within the build chamber. In some aspects, the methods disclosed herein further may include translating the build chamber along the z-axis prior to additional powder deposition after forming a bound layer. In some aspects, the methods disclosed herein further may include depositing fresh and/or loose powder from a hopper. In some aspects, the methods disclosed herein further may include repeating all or a portion of the steps disclosed herein until a green part is formed. In some aspects, the methods disclosed herein further may include sintering the green part to form a final part.

In some aspects, the methods disclosed herein further may include translating a bottom of the build chamber along the z-axis. In some aspects, the methods disclosed herein further may include delivering at least one impulse to a build chamber while the bottom of the build chamber is elevated above at least one wall of the build chamber.

In some aspects, the methods disclosed herein further may include determining the resonant frequency of the apparatus by delivering at least one impulse to the apparatus or a component thereof, e.g., the build chamber. As described herein, delivering at least one impulse at a repetition rate substantially corresponding to the resonant frequency of the apparatus may aid in increasing the density of the powder within the powder bed or maximizing the removal of unbound powder particles after printing a green part. Once the resonant frequency of the apparatus including any fresh and/or loose powder within the build chamber is identified, at least one impulse may be delivered to the build chamber at the corresponding repetition rate during the appropriate stage of the binderjet printing process, e.g., densifying fresh and/or loose powder and/or gross depowdering following printing.

### EXAMPLES

### Example 1

The present example describes a build chamber defining a volume holding a deposited powder used for forming an unbound settled powder by delivering a plurality of impulses.

Table 1 shows an example of a powder densification experiment performed using apparatus and methods disclosed herein on a MIM powder blend of PF-13/13FF stainless steel. For the results described in Table 1, fresh and/or loose powder was added to a build chamber as described herein. Impulses, via a mechanical impact, were delivered in a single motion by an ultrasonic generator. For example, the build chamber is physically impacted by a discrete mechanical impulse. The single motion discrete mechanical impulse was repeated multiple times.

TABLE 1
Densification of MIM powder blend
of PF-13/13FF in a build chamber

| | |
|---|---|
| Initial Volume (cm³) | 52 |
| Mass (g) | 191.33 |
| Final Volume (cm³) | 38 |
| Initial Density (g/cm³) | 3.679 |
| Final Density (g/cm³) | 5.035 |
| % Volume Reduction | 26.92% |

### Example 2

The present example describes a build chamber defining a volume holding a deposited powder used for forming an unbound settled powder by delivering a plurality of impulses.

MIM PF-13/13FF stainless steel powder blend was spread into the base of the build chamber apparatus. An apparatus similar to the apparatus shown in the schematic of FIGS. 1A-1E was used for this experiment. An unbound settled powder was formed by impacting the base of a build chamber apparatus with a plurality of impulses using a mallet.

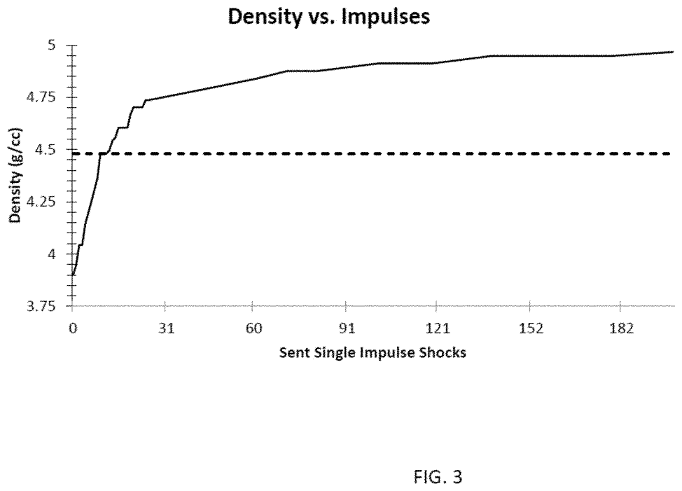

Table 2 and FIG. 3 illustrate the resulting data from delivering the plurality of single impulses using a mallet and asymptotically settling the powder. Table 2 in particular shows the initial and final powder density. FIG. 3 shows a graph plotting the change in density as measured following each impulse of the plurality of impulse shocks delivered to the apparatus. The dotted line in FIG. 3 represents the tap density value reported by the MIM powder manufacturer. The tap density represents an increase in bulk density after settling. FIG. 3 exhibits asymptotic settling of the powder from delivering a plurality of impulses. As shown, the powder continued to settle after 200 impulses impacted with the apparatus by the mallet. As further shown in FIG. 3, the density of the powder, after settling using the apparatus and methods disclosed herein, exceeds the tap density of the powder and approaches the density limit of a solid material.

TABLE 2
Densification of MIM powder blend
of PF-13/13FF in a build chamber

| | |
|---|---|
| Initial Volume (cm³) | 85 |
| Mass (g) | 331.53 |
| Final Volume (cm³) | 67 |
| Initial Density (g/cm³) | 3.900 |
| Final Density (g/cm³) | 4.948 |
| % Volume Reduction | 21.17% |

### Example 3

In this Example, the gross removal of unbound powder, i.e., gross depowdering, from green parts formed from a binderjet printing process is illustrated. As described herein, a binderjet printing process forms green parts from unbound powder particles be selectively jetting a binder material into a powder bed of the particles to found selectively bound particles surrounded by excess unbound powder.

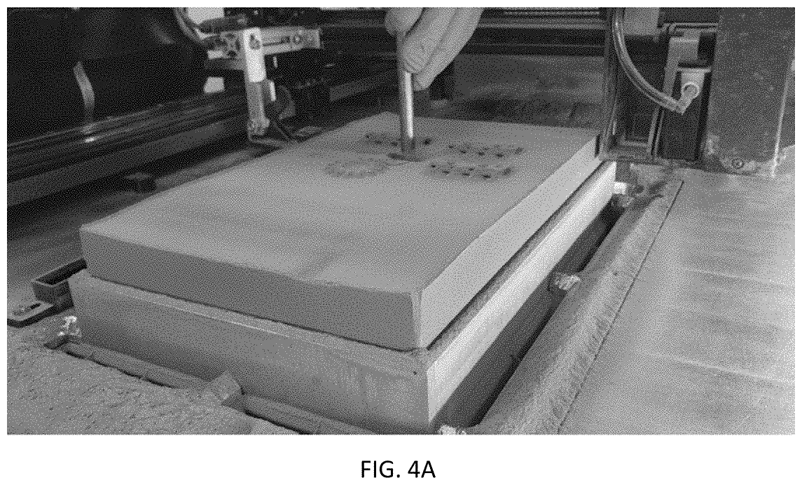

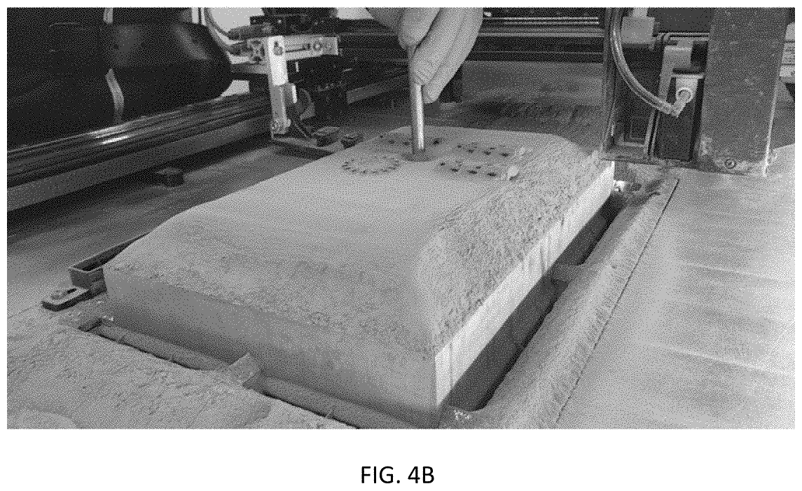

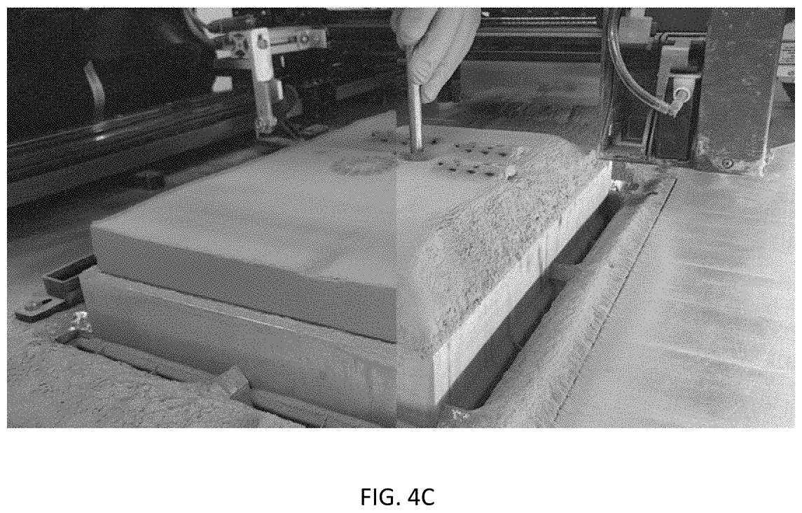

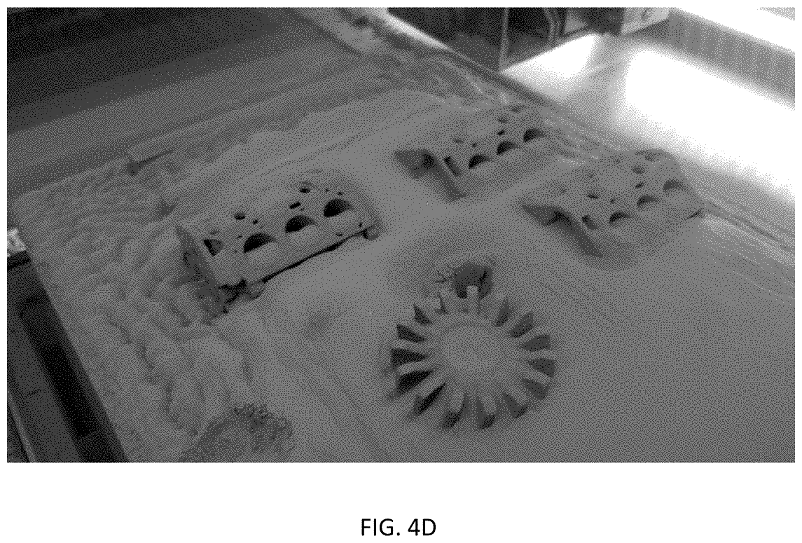

FIG. 4A illustrates the powder bed of the build chamber with the green parts formed therein. The powder bed has been elevated above the walls of the build chamber to expose the powder bed. The green parts were formed by jetting binder material into the powder bed, leaving behind the visible entrance holes on the top surface of the powder bed.

FIG. 4B illustrates the partial removal of unbound powered from the build chamber to expose the green parts formed therein. Illustrated in FIG. 4B is a delivery head including a shaft and a mallet (mallet not visible) with the shaft in contact with the build chamber. Impulses were applied to the build chamber by the operator striking the shaft with the mallet, transferring the impulse to the build chamber. It is to be appreciated that such a powder printing system may include any type of delivery head to deliver at least one impulse to the build chamber, such as the delivery head 150 illustrated herein in FIGS. 1A-2. As is illustrated, the impulse delivered to the build chamber began to fluidize the unbound particles, causing them to fall away from the elevated powder bed and into a separate region of the printing system via the gaps and channels surrounding the build chamber. A direct comparison of the shape of the powder bed before and after delivery of impulses to the build chamber is shown in FIG. 4C, with the left portion of the figure showing the powder bed “before” impulse delivery (FIG. 4A) and the right portion of the figure showing the powder bed “after” impulse delivery (FIG. 4B).

FIG. 4D illustrates the exposure of the green parts after gross depowdering was continued using the delivery of impulses to the build chamber. As is illustrated, much of the unbound powder was removed from the green parts by the continued application of impulses to the build chamber. The remaining unbound powder may be removed from the green parts using any number of techniques.

The phraseology and terminology used herein is for the purpose of description and should not be regarded as limiting. As used herein, the term “plurality” refers to two or more items or components. The terms “comprising,” “including,” “carrying,” “having,” “containing.” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third.” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only. Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. An apparatus for additively manufacturing an object, comprising:
a build chamber defined by a volume;
an extruder positioned over the volume of the build chamber; and
one or more delivery heads configured to deliver at least one impulse to the build chamber.

2. The apparatus of claim 1, wherein the one or more delivery heads is further configured to asymptotically settle, through application of the delivered at least one impulse, fresh and/or loose powder within the build chamber to form an unbound settled powder.

3. The apparatus of claim 1, wherein the one or more delivery heads is further configured to fluidize, through application of the delivered at least one impulse, unbound settled powder within the build chamber for removal from the build chamber.

4. The apparatus of claim 1, wherein the one or more delivery heads is a mallet.

5. The apparatus of claim 4, wherein the mallet is configured to deliver a single impact to a base of the build chamber.

6. The apparatus of claim 5, wherein the mallet is configured to deliver a plurality of impacts to the base of the build chamber.

7. The apparatus of claim 4, further comprising a piston, wherein a head of the mallet is adapted to an end of the piston.

8. The apparatus of claim 1, wherein the one or more delivery heads comprises a mallet and the at least one impulse is delivered to a location substantially geometrically central to a base of the build chamber.

9. The apparatus of claim 1, wherein the one or more delivery heads comprises a mallet and the at least one impulse is delivered to a location substantially center of mass to the volume of the build chamber.

10. The apparatus of claim 1, wherein the one or more delivery heads comprises a source of vibrational energy.

11. The apparatus of claim 1, wherein the one or more delivery heads are configured to deliver at least one impulse to the build chamber such that a density of the unbound settled powder is substantially uniform.

12. The apparatus of claim 1, wherein the extruder comprises a binderjet extruder configured to translate across a surface area the volume of the build chamber.

13. The apparatus of claim 12, wherein the extruder is configured to selectively jet binder to form portions of bound powder across a surface of the volume of the build chamber.

14. The apparatus of claim 1, wherein the one or more delivery heads comprises a mallet configured to deliver the at least one impulse to a surface of the build chamber.

15. The apparatus of claim 1, wherein the one or more delivery heads comprises a roller.

16. The apparatus of claim 1, wherein the one or more delivery heads is comprises a powder hopper.

17. The apparatus of claim 1, wherein a base of the build chamber is configured to translate along a z-axis of the apparatus.

18. The apparatus of claim 17, wherein the one or more delivery heads are configured to deliver at least one impulse to the build chamber when the base of the build chamber is elevated away from at least one side of the build chamber.

19. The apparatus of claim 17, wherein a base of the build chamber comprises one or more coverable openings.

20. The apparatus of claim 1, further comprising a vacuum source operatively coupled to the build chamber.

21. A method of forming an additively manufactured object, comprising steps of:
depositing a layer of a powder into a build chamber;
selectively jetting binder ink from an extruder onto at least a portion of the powder to form a selectively jetted bound powder and a remaining amount of unbound powder; and
delivering at least one impulse to the build chamber.

22. The method of claim 21, wherein delivering at least one impulse includes delivering the at least one impulse to asymptotically settle the powder to form a settled unbound powder and wherein selectively jetting the binder ink includes jetting the binder ink onto the settled unbound powder.

23. The method of claim 21, wherein the delivered at least one impulse fluidizes a portion of the remaining amount of unbound powder in the build chamber for removal.

24. The method of claim 21, wherein the delivering comprises impacting one or more delivery heads with a surface of a base of the build chamber.

25. The method of claim 21, wherein the delivering comprises impacting surface of a base of the build chamber with the one or more delivery heads adapted to an end of a piston.

26. The method of claim 21, wherein the delivering comprises impacting surface of a base of the build chamber with the one or more delivery heads being a mallet.

27. The method of claim 21, wherein the delivering comprises a delivering a single impulse.

28. The method of claim 21, wherein the delivering comprises a delivering a plurality of impulses.

29. The method of claim 24, wherein the delivering comprises delivering an impact to a surface of the base of the build chamber.

30. The method of claim 24, wherein the delivering comprises delivering an impact to the base at a location that is substantially geometrically central to the base of the build chamber.

31. The method of claim 24, wherein the delivering comprises delivering an impact to the base at a location that is substantially near the center of mass of the build chamber.

32. The method of claim 21, wherein the delivering comprises application of vibrational energy to a surface of a base of the build chamber.

33. The method of claim 32, wherein the applying of vibrational energy comprises actuating a vibration source operatively coupled to the build chamber.

34. The method of claim 23, further comprising opening one or more coverable openings in a base of the build chamber.

35. The method of claim 34, wherein the delivery of the at least one impulse to the build chamber fluidizes a portion of the remaining amount of unbound powder to allow it to pass through the opened one or more coverable openings.

36. The method of claim 21, wherein the delivery of the at least one impulse to the build chamber results in a density of the unbound settled powder that is substantially uniform.

37. The method of claim 21, wherein the delivering comprises:
generating sound with a speaker; and
transmitting the sound to the build chamber the speaker.

38. The method of claim 21, further comprising translating a base of the build chamber along the z-axis.

39. The method of claim 38, further comprising delivering at least one impulse to the build chamber while the base of the build chamber is elevated above at least one wall of the build chamber.

40. The method of claim 21, further comprising adjusting the repetition rate of the at least one impulse delivered to the build chamber to substantially correspond to a resonant frequency of the build chamber.

41. The method of claim 21, further comprising:
depositing subsequent fresh and/or loose powder to the build chamber; and
delivering at least one impulse to the build chamber to asymptotically settle the powder to form a settled unbound powder.

42. The method of claim 41, further comprising, prior to the step of depositing subsequent powder to the build chamber, translating a base of the build chamber along a z-axis of the apparatus at a repeatable z-axis step position.
